(19) United States
(12) Patent Application Publication
(10) Pub. No.: US 2026/0211464 A1
(43) Pub. Date: Jul. 23, 2026

(54) HINGES FOR WEARABLE ELECTRONIC DEVICE

(71) Applicant: Apple Inc., Cupertino, CA (US)

(72) Inventors: Paul Williams, Seattle, WA (US); Jonathan M. Anderson, San Francisco, CA (US)

(21) Appl. No.: 19/280,335

(22) Filed: Jul. 25, 2025

Related U.S. Application Data
(60) Provisional application No. 63/747,209, filed on Jan. 20, 2025.

(51) Int. Cl. G06F 1/16; F16C 11/04

(52) U.S. Cl. CPC G06F 1/1681; F16C 11/04; G06F 1/163

(57) ABSTRACT

A wearable electronic device includes a hinge having a housing and a central shaft disposed within the housing. A link can extend from the shaft and a distal end of the link is configured to rotatably engage an inner portion of an arm of the device. The arm is coupled to the frame via the hinge and the arm can be electrically coupled to the frame via an electrical connector passing through the hinge. The wearable electronic device includes a pivot shaft fixed to the central shaft and rotatably coupled to the link. In some examples, the central shaft includes an energy storage member, and the hinge is bi-stable.

### CROSS-REFERENCE TO RELATED APPLICATIONS

This application claims the benefit of U.S. Provisional Application No. 63/747,209; filed 20 Jan. 2025, entitled “HINGES FOR WEARABLE ELECTRONIC DEVICE,” the entire disclosure of which is hereby incorporated by reference.

### FIELD

The present disclosure relates generally to wearable electronic devices. More particularly, the present disclosure relates to hinges and hinge mechanisms for wearable electronic devices.

### BACKGROUND

Recent advances in portable computing have led to advancements in wearable electronic devices designed to interact with the user while being worn. Some wearable devices, such as head mountable devices (HMDs) including virtual reality (VR) headsets, smart glasses, and the like, can have modular or reconfigurable components that can be rearranged for different purposes. Some HMDs can include securement arms that extend from the frame in an open position, and which can be folded into a stowed position when not being used. The various electrical components within HMDs, including some components which may reside within the arms and others within the viewing frame, often benefit from maintaining functionality in both positions. HMDs currently offer no hinges, joints, or other mechanisms that allow for the reconfigurability of the arms (or securement bands of VR headsets) while maintaining electronic component functionality and stable physical positioning of the device in different use scenarios.

### SUMMARY

In at least one example of the present disclosure, a wearable electronic device can include a frame coupled to a display window. In some examples, the wearable electronic device can also include an arm extending from the frame. In some examples, the wearable electronic device also includes an electrical connector. In some examples, the wearable electronic device also includes a hinge having a housing. In some examples, the hinge includes a central shaft disposed within the housing. In some examples, the hinge includes a link extending from the shaft. In some examples, es a distal end of the link is configured to rotatably engage an inner portion of the arm. In some examples, the arm is electrically coupled to the frame via the electrical connector and the arm is coupled to the frame via the hinge. In some examples, the hinge includes a pivot shaft fixed to the central shaft and rotatably coupled to the link. In some examples, the central shaft includes an energy storage member. In some examples, the electrical connector passes through the hinge. In some examples, the hinge is bi-stable.

In at least one example of the present disclosure, a hinge for a wearable electronic device can include a housing, a shaft disposed within the housing and includes an energy storage member, and a link extending from the shaft. In some examples, the hinge also includes and a retention member. In some examples, the energy storage member is coupled to the link, the link rotatably engages the retention member, and a rotation of the hinge causes the link to deform the energy storage member such that the link changes an energy characteristic of the energy storage member. In some examples, the hinge is a bi-stable hinge. In some examples, the energy storage member is a spring. In some examples, the hinge defines an axis of rotation, the hinge further includes an electrical connector, and the shaft is disposed between the electrical connector and the axis of rotation. In some examples, the hinge defines a first axis of rotation, and the link rotates about a second axis of rotation perpendicular to the first axis of rotation. In some examples, the shaft is a first shaft, and a second shaft is fixed to the first shaft and rotatably coupled to the link. In some examples, the shaft is fixed to the housing, and the link rotates about an axis defined by the shaft.

In at least one example of the present disclosure, a wearable electronic device can include a frame coupled to a display and defining a volumetric envelope. In some examples, the wearable electronic device also includes an arm extending from the frame. In some examples, the wearable electronic device also includes a hinge coupling the arm to the frame, and the hinge includes a four-bar linkage. In some examples, the hinge defines a first position of the arm relative to the frame and a second position of the arm relative to the display, the four-bar linkage guides the arm between the first position and the second position, the arm is disposed outside the volumetric envelope in the first position, and the arm is disposed within the volumetric envelope in the second position. In some examples, the four-bar linkage includes a first link, a second link, a third link, and a fourth link, the wearable electronic device further including an electrical connector, and the electrical connector is disposed within the first link.

In some examples, the arm is a first arm, the wearable electronic device includes a second arm, the second arm is disposed outside the volumetric envelope in the first position, and the second arm is disposed within the volumetric envelope in the second position. In some examples, the hinge is a bi-stable hinge. In some examples, the wearable electronic device includes a spring coupled to the central shaft and the link. In some examples, a rotation of the hinge causes the link to rotate about a first axis defined by the inner portion of the arm, rotate about a second axis defined by the pivot shaft, and change the length of the spring. In some examples, the link deforms the energy storage member in response to a rotation of the hinge. In some examples the second link defines a stop feature configured to receive the first link.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of an example of a wearable electronic display device;

FIG. 1B shows a perspective view of an example wearable electronic display device;

FIG. 2A shows a top view of an example of a wearable electronic display device in a first position;

FIG. 2B shows a top view of an example of a wearable electronic display device in a second position;

FIG. 3A shows a top view of an example of a wearable electronic display device in a first position;

FIG. 3B shows a top view of an example of a wearable electronic display device in a second position;

FIG. 4A shows a top cross-sectional view of an example hinge section in a first position;

FIG. 4B shows a top cross-sectional view of an example hinge section in a second position;

FIG. 4C shows a top cross-sectional view of an example hinge section in a third position;

FIG. 5A shows a side cross-sectional view of an example hinge in a first position;

FIG. 5B shows a side cross-sectional view of an example hinge a first position;

FIG. 6A shows side cross-sectional view of an example hinge in a first position;

FIG. 6B shows side cross-sectional view of an example hinge in a second position;

FIG. 6C shows side cross-sectional view of an example hinge in a third position;

FIG. 7A shows side cross-sectional view of an example of a hinge in a first position;

FIG. 7B shows side cross-sectional view of an example of a hinge in a second position;

FIG. 8A shows side cross-sectional view of an example of a hinge in a first position;

FIG. 8B shows side cross-sectional view of an example of a hinge in a second position;

FIG. 8C shows side cross-sectional view of an example of a hinge in a third position;

FIG. 9 shows a side view of an example of a hinge section;

FIG. 10A shows a top cross-sectional view of an example of a hinge in a first position;

FIG. 10B shows a top cross-sectional view of an example of a hinge in a second position; and

FIG. 10C shows a top cross-sectional view of an example of a hinge in a third position.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The present disclosure relates generally to wearable electronic devices. More particularly, the present disclosure relates to hinges and hinge mechanisms for wearable electronic devices. Wearable devices, such as head mountable devices including virtual reality (VR) headsets, smart glasses, and the like, can have modular or reconfigurable components that can be rearranged for different purposes. Smart glasses, for example, include securement arms that extend from the frame in an open position, and which can be folded into a stowed position after use. These reconfigurable securement arms also house electronic components that communicate with electronic components of the display frame. When donning and using the smart glasses, the arms can extend straight out from the frame. When stowing the smart glasses, the arms can be folded in toward the frame to reduce the overall size. Head mountable devices currently do not include hinges, joints, or other mechanisms that allow for the reconfigurability of the arms (or securement bands of VR headsets) while maintaining electronic component functionality and stable physical positioning of the device in different use scenarios.

The present disclosure includes hinge mechanisms for such securement arms, including hinge assemblies and systems that maintain stable positions, whether open for use or closed for stowing, while accommodating electrical components and connections through the hinge. For example, in one hinge assembly, a central shaft can pass through a hinge housing between the glasses frame and the securement arm. Links extending from either end of the shaft can rotate as the hinge is actuated to engage an inner surface of the securement arm and the frame. This engagement between the links and the arms and frame of the glasses can guide the motion of the arms in a bi-stable way to stabilize the arms in both the open and closed configuration.

The shaft can be arranged in such a way as to provide room for electrical connections and components to pass through the hinge assembly uninterrupted. Electrical cables or flexes, for example, can pass behind the shaft and avoid contact with the links or housing of the hinge assembly. In this way, the electrical components can continue to function or at least be un-perturbed in the closed position as well as the open position of the arms.

In one example, the shaft (or multiple shafts) of the hinge assembly can be flexible to provide the bi-stability. In another example, the links can engage each end of the shaft with a spring (e.g., a coil spring through which the shaft passes), which allows an axial movement of the links relative to the shaft as the links engage the inner surfaces between the open and closed positions. The links can extend away from the shaft during movement and return toward the shafts in either arm position to create the bi-stable force of the open or closed arm.

Other hinge mechanisms can include four-bar linkages configured to guide the pivoting movement of the arm from the open to closed position in an intentional manner. In one example, a four-bar linkage can position the arm in a stable manner when open such that the exterior surfaces of the arm and frame mate in an uninterrupted and aesthetically pleasing way. Then, when stowed, the four-bar linkage can position the arm(s) to fold within a volumetric envelope of the frame, for example with various external surfaces of the arms being flush or sub-flush with an external surface or boundary defined by the frame. In this way, the arms are protected when in the stowed position.

Accordingly, hinges and hinge mechanisms described herein provide bi-stable positioning of arms for head-mountable electronic devices between open and stowed positions while maintaining device functionality, component protection, and aesthetic appeal.

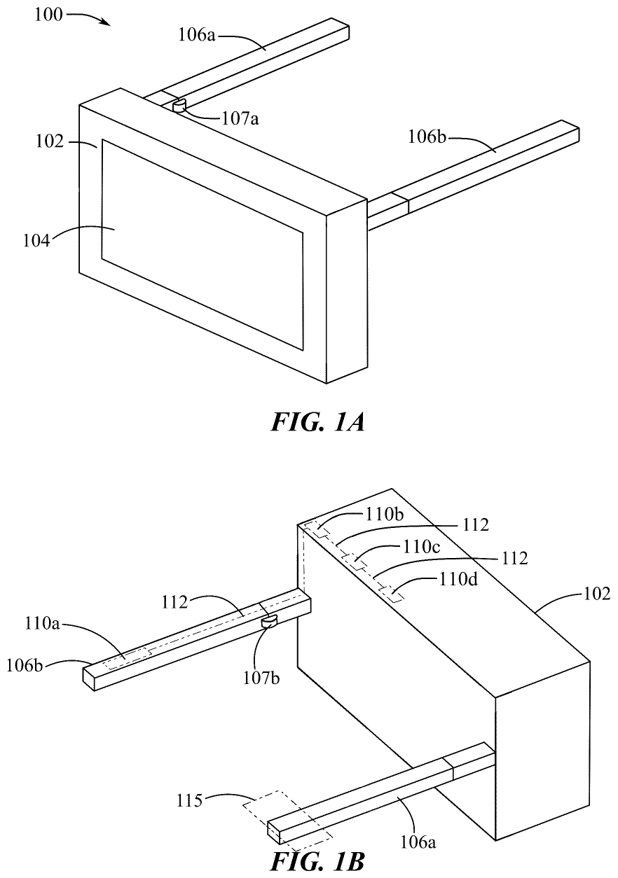

These and other embodiments are discussed below with reference to FIG. 1A-FIG. 10C. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 shows an example of a wearable electronic display device 100. The wearable electronic display device 100 can be a head-mounted device, resting on the face of a user and being supported by the head, nose, ears, and/or other body part of a user. In some examples, the wearable electronic display device 100 can provide a user with a visual or auditory experience. In some examples, the wearable electronic display device 100 can be an augmented reality device or a virtual reality device. The wearable electronic display device 100 can include a display frame 102 coupled to a display window 104. In some examples, the display window 104 can be at least partially transparent, allowing a user to see through the display window 104. The display window 104 can overlay information, graphics, video, or other media over the field of view of a user. In other examples, the display window 104 can be a screen that at least partially fills the field of view of a user. The screen can be a LED screen, an OLED screen, a projection, an LCD screen, or another type of screen.

The wearable electronic display device 100 can also include securement arms 106a-b extending distally from the display frame 102. The securement arms 106a-b can rest on the ears of a user and/or engage a side of a user's head and can at least partially support the wearable electronic display device 100. In some examples, the securement arms 106a-b can be manufactured from polymers, composites, or metals. Each of the securement arms 106a-b can be injection molded, cast, or machined. In some examples, the wearable electronic display device 100 can include one or more hinges 107a-b. In some examples, securement arm 106a can be foldably attached to the display frame 102 via hinge 107a. In some examples, securement arm 106b can be foldably attached to the display frame 102 via hinge 107b (shown in FIG. 1B). Foldable securement arms 106a-b can collapse inward toward the display frame 102, increasing portability and decreasing the stowed size of the wearable electronic display device. Foldable securement arms 106a-b can also enable the securement arms 106a-b to fold inward toward the display frame 102 during a drop event, preventing damage to the wearable electronic display device 100. In some examples, or more of the hinges 107a-b can be bi-stable hinges.

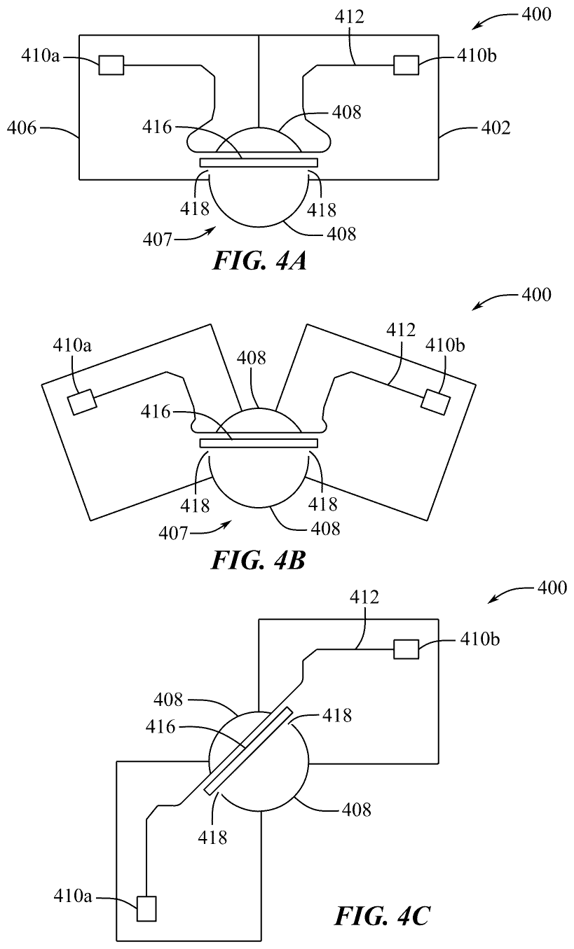

FIG. 1B shows another perspective view of a wearable electronic device 100. In some examples, the wearable electronic device 100 can include electronic components 110a-d. The electronic components 110a-d can include speakers, batteries, processors, projectors, electrical connectors, and/or other electronic components. In some examples, the electrical components 110a-d can be electrically coupled to one another via an electrical connector 112. In some examples, one electronic component 110a can be disposed within arm 106b on one side of the hinge 107b, and another electronic component 110b can be disposed within the frame 102 on the other side of the hinge 107b. In some examples, the electrical connector 112 can extend from electronic component 110a through the hinge 107b to electronic component 110b. FIG. 1B also shows a horizontal plane 115 at which the cross-sectional view shown in FIGS. 4A-4C is taken.

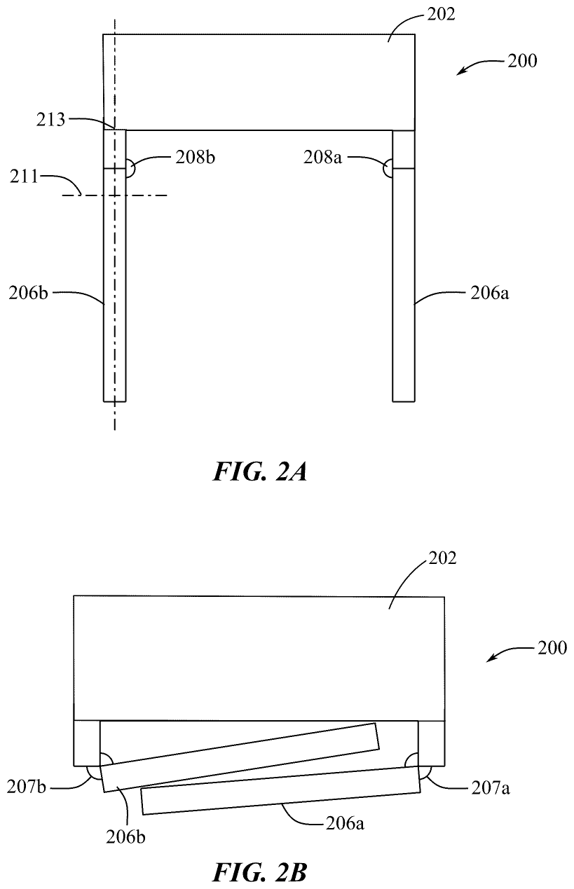

Any of the features, components, and/or parts, including the arrangements and configurations thereof shown in FIG. 1A-1B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 1A-1B. More examples of wearable electronic display devices with bi-stable hinges are discussed below in reference to FIGS. 2A-2B.

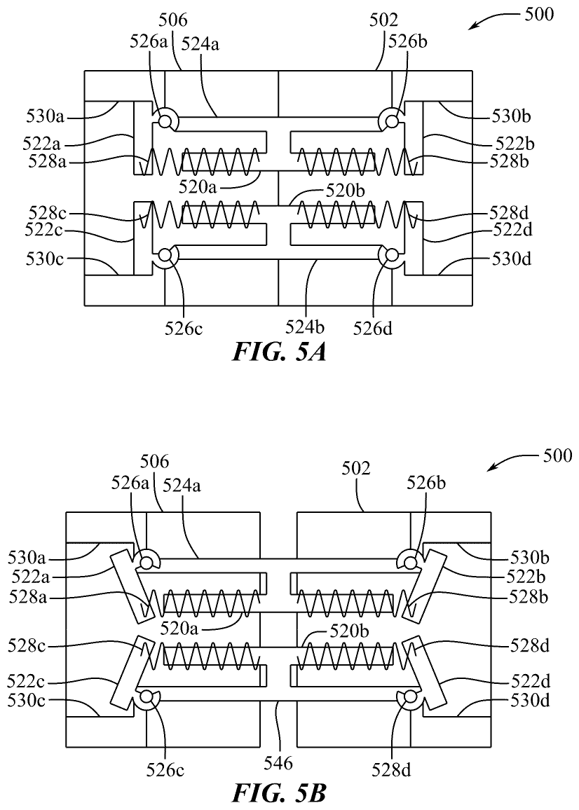

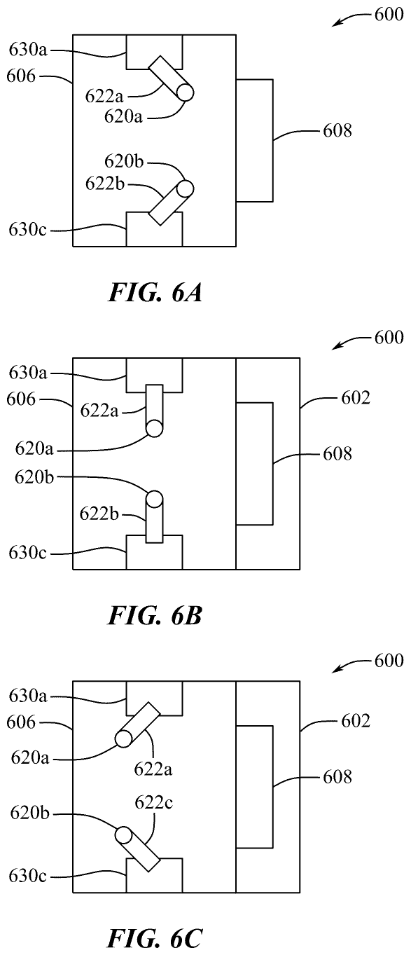

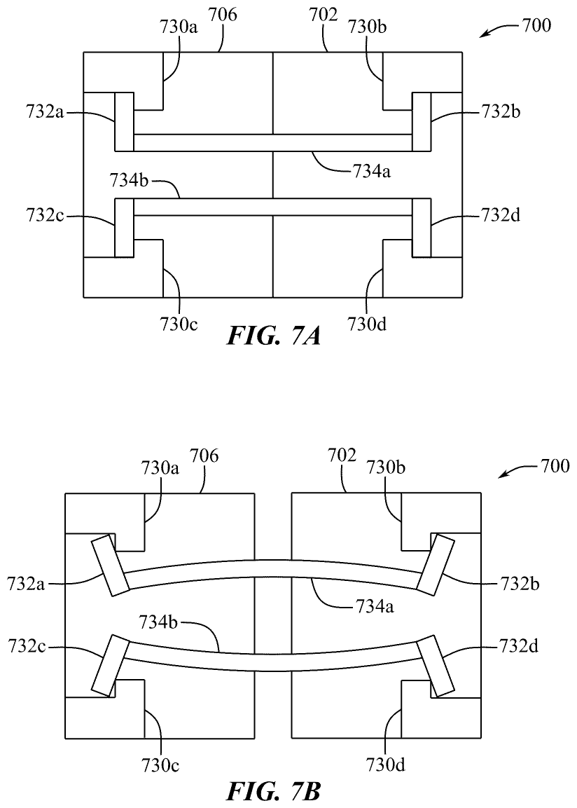

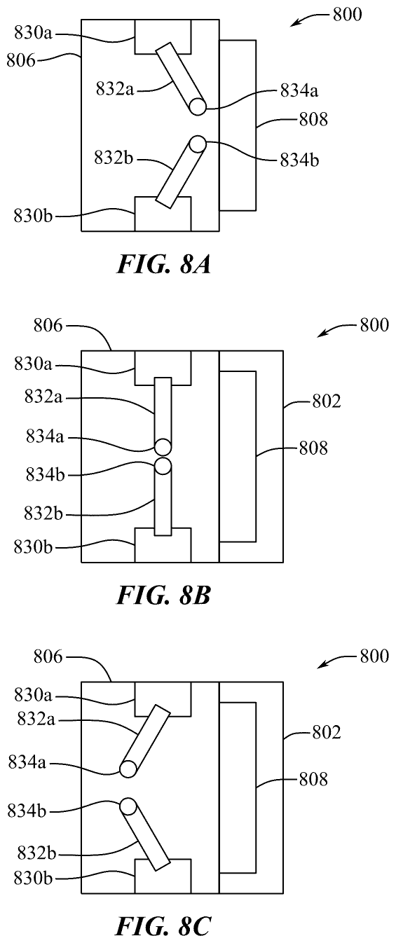

FIG. 2A shows a top view of an example of a wearable electronic display device 200 in a first position. In some examples, the first position is an open position. The wearable electronic display device 200 can include a frame 202, and arms 206a-b extending from the frame 202. In some examples, the arms 206a-b can be rotatably coupled to the frame 202 via hinges 107a-b respectively. FIG. 2A also shows a front plane 211 and a side plane 213. The side plane 213 is the plane at which the cross-sectional views of FIGS. 5A-5B and FIGS. 7A-7B are taken. The front plane 211 is the plane at which the cross-sectional views of FIGS. 6A-6C and FIGS. 8A-8C are taken.

FIG. 2B shows the wearable electronic display device 200 in a second position. In some examples, the second position is a closed position. In some examples, the arms 206a-b can fold inward toward the frame 202 about the hinges 207a-b respectively. In some examples, the arms 206a-b can fold toward the frame 202 an equal amount. In other examples, arm 206b can fold in more than arm 206a or vice versa. In other words, arm 206b can create a smaller angle between the arm 206b and the frame 202 than arm 206a or vice versa. The hinges 207a-b can include hard-stop features to prevent over extension of the hinges, and define the closed position of the arms 206a-b. In some examples, rotation of the arms 206a-b can expose parts of the hinges 207a-b. In some examples, the arms 206a-b and the frame 202 can include gaskets or other seals to prevent water, dust, or other contaminants from entering the wearable electronic display device 200.

In some examples, the hinges 207a-b can also be waterproof, including seals or gaskets. In other examples, the hinges 207a-b can be exposed to water, dust, or other foreign materials while any interior electrical connectors can themselves be sealed, instead of the hinge being sealed. Sealing the internal components of the wearable electronic display device 200 can increase the longevity of the wearable electronic display device 200, protect sensitive electronic components, prevent deterioration such oxidation, and help the hinges 207a-b function smoothly. In some examples, an unsealed hinge 207a-b can save internal space and allow for more electrical components or electrical connectors to pass through the hinges 207a-b or can simplify the manufacturing process.

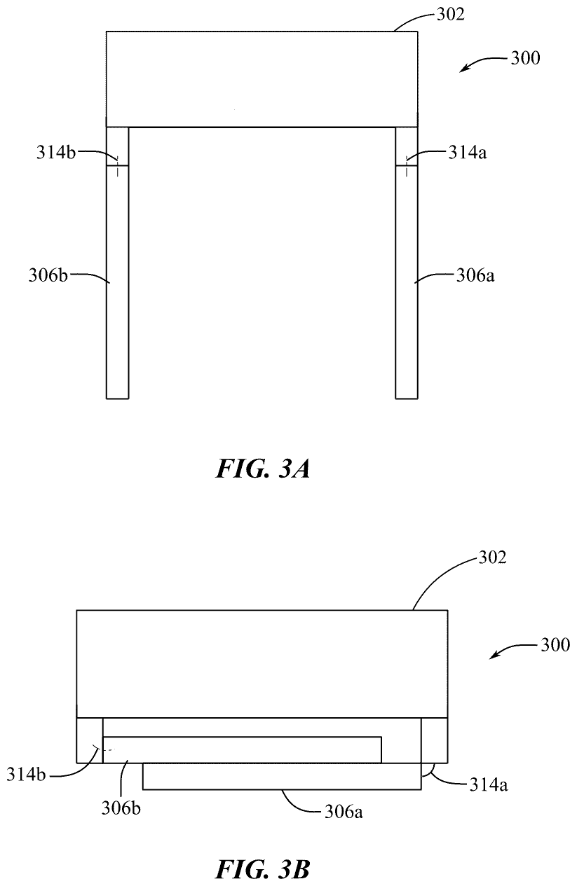

Any of the features, components, and/or parts, including the arrangements and configurations thereof shown in FIG. 2A-2B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 2A-2B. More examples of wearable electronic display devices with complex folding capabilities are discussed below in reference to FIGS. 3A-3B.

FIG. 3A shows an example of a wearable electronic display device 300 in a first position. In some examples, the first position can be an open position. In some examples, the wearable electronic display device 300 can include a frame 302 and arms 306a-b extending from the frame 302. The frame 302 can define a volumetric envelope. The volumetric envelope is shown in FIG. 3 as the smallest rectangular area within which the frame 302 fits. In other examples including frames having other non-rectangular profiles and shapes, such as curves frames 302 and so forth, the volumetric envelope can be a corresponding shape or cross-sectional area within which the frame fits. In some examples, arm 306a is a first arm, and arm 306b is a second arm. In some examples, the arms 306a-b can be rotatably coupled to the frame 302 via hinges 314a-b respectively. In some examples, the hinges 314a-b can be partially or wholly disposed within the frame 302 and the arms 306a-b. In some examples, the hinges 314a-b can include four-bar linkages. In some examples, the hinges 107a-b define the first position of the arms 106a-b relative to the frame 302 shown in FIG. 3A, and the second position of the arms 306a-b relative to the frame 302 shown in FIG. 3B. In the first position, the arms 306a-b can be disposed outside the volumetric envelope defined by the frame 302, as shown in FIG. 3A. In some examples, the four-bar linkages of the hinges 314a-b can guide the arms 306a-b between the first position shown in FIG. 3A and the second position shown in FIG. 3B.

FIG. 3B shows an example of a wearable electronic display device 300 in a second position. In some examples, the second position can be a closed position. In some examples, at least one of the arms 306a-b can be disposed within the volumetric envelope defined by the frame 302 in the second position. In some examples, both arms 306a-b can be wholly disposed within the volumetric envelope defined by the frame 302 in the second position. In other examples, arm 306b can be partially disposed within the volumetric envelope defined by the frame 302 in the second position, in yet other examples, both arms 306a-b can be partially disposed within the volumetric envelope defined by the frame 302 in the second position. Disposition of the arms 306a-b within the volumetric envelope defined by the frame 302 in the second position can decrease the overall size of the wearable electronic display device 300, protect the arms 306a-b from outside forces or drop events, and allow for easier transport or storage of the wearable electronic display device 300. In some examples, the hinges 314a-b can be bi-stable hinges with stability in the first position and the second position. In some examples, the four-bar linkages of the hinges 314a-b can guide the arms 306a-b from the first position to the second position.

Any of the features, components, and/or parts, including the arrangements and configurations thereof shown in FIG. 3A-3B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 3A-3B. Hinge cable management and optimization is described in more detail below.

FIG. 4A-4C shows a top cross-sectional view of a hinge section 400, taken at the plane 115 shown in FIG. 1B. FIG. 4A shows the hinge section 400 in a first position. The first position can be an open position. In some examples, the hinge section 400 can include an arm 406, a frame 402, and a hinge 407 coupling the arm 406 to the frame 402. In some examples, the hinge 407 can include a housing 408. In some examples, the hinge 407 can be a bi-stable hinge. The arm 406 can include a first electronic component 410a, and the frame 302 can include a second electronic component 410b. In some examples, the first electronic component 410a can be electrically coupled to the second electronic component 410b via an electrical connector 412. In some examples, the electrical connector 412 can be a cable, a cable bundle, a flex, or another electrical connector. In some examples, the electrical connector 412 can be a flexible electrical connector. In some examples, the housing 408 can define a channel 418 through which the electrical connector 412 can pass. In some examples, the channel 418 can be concealed by the arm 406 and the frame 402 in any position shown in FIGS. 4A-4C.

In some examples, the hinge 407 can also include an internal mechanism 416. In some examples, the internal mechanism can be partially disposed within the housing 408. In some examples, the internal mechanism 416 can be a shaft. In some examples, the internal mechanism 416 can be disposed between the electrical connector 412 and the axis of rotation of the hinge, as shown in FIGS. 4B-4C. As shown the housing 408 can be cylindrical. In some examples, the center of the cylinder of the housing 408 can be the axis about which the hinge rotates. In some examples, the internal mechanism 416 and the electrical connector 412 can be offset from the axis of rotation of the hinge.

FIG. 4A shows a first position in which the hinge 407 is open and the arm 406 is extended away from the frame 402. The first position can be an open position and can be stable. FIG. 4B shows a second position in which the hinge 407 is partially closed, and the arm 406 is rotating toward the frame 402. The second position can be an intermediary position and can be unstable. FIG. 4C shows a third position in which the hinge 407 is fully closed, and the arm 406 has rotated toward the frame 402. The third position can be a closed position and can be stable. As shown in FIGS. 4A-4C, the hinge 407 allows the electrical connector 412 to pass through the hinge 407 in any position between the first position and the third position while minimizing the bending of the electrical connector 412. In some examples, the electrical connector 412 does not bend past approximately 30 degrees. In other examples, the electrical connector 412 does not bend past approximately 45 degrees. In other examples, the electrical connector 412 does not bend past approximately 60 degrees. In yet other examples, the electrical connector 412 does not bend past approximately 90 degrees. Minimizing bending of the electrical connector 412 can prevent electrical interference, increase the longevity of the electrical connector 412, and allow for compact cable management.

Any of the features, components, and/or parts, including the arrangements and configurations thereof shown in FIG. 4A-4C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 4A-4C. More examples of hinges and hinge mechanisms are described in detail below.

FIGS. 5A-5B show a cross-sectional view of a hinge 500 taken at the plane 213 shown in FIG. 2A. The hinge shown in FIGS. 5A-5B can be a bi-stable hinge including rotating parts and energy storage parts that interact to create bi-stability in an open and closed position, with an unstable set of middle positions. The hinge 500 can include an arm 506, a frame 502, a central shaft 520a, and a link 522a extending from the central shaft 520a. In some examples, the central shaft 520a can include a spring 528a coupled to the link 522a. In some examples, a distal end of the link 522a can be configured to rotatably engage an inner portion 530a of the arm 506. In some examples, the hinge 500 can also include a pivot shaft 524a. The pivot shaft 524a can be fixed to the central shaft 520a or can be fixed to another portion of the hinge 500. In some examples, the link 522a can be pivotally coupled to the pivot shaft 524a at a point 526a. In some examples, the central shaft 520a and the pivot shaft 524a can extend through the hinge 500 from the arm 506 to the frame 502. In some examples, the central shaft 520a can be a first central shaft 520a and the pivot shaft can be a first pivot shaft 524a. The link 522a can be a first link 522a, the point 526a can be a first point 526a, the spring 528a can be a first spring 528a, and the inner potion 530a can be a first inner portion 530a. In some examples, the hinge can include a second link 522b opposite the first link 522a and extending from the first central shaft 520a. In some examples, the first central shaft 520a can include a second spring 528b opposite the first spring 528a and coupled to the second link 522b. In some examples, a distal end of the second link 522b can be configured to rotatably engage an inner portion 530b of the frame 502. In some examples, the second link 522b can be pivotally coupled to the pivot shaft 524a at a second point 526b.

In some examples, the hinge 500 can include a second central shaft 520b and a second pivot shaft 524b. In some examples, the second central shaft 520b and the second pivot shaft 524b can extend through the hinge 500 from the arm 506 to the frame 502. In some examples, the hinge 500 can include a third link 522c extending from the second central shaft 520b. In some examples, the second central shaft 520b can include a third spring 528c coupled to the third link 522c. In some examples, a distal end of the third link 522c can be configured to rotatably engage an inner portion 530c of the arm 506. In some examples, the third link 522c can be pivotally coupled to the second pivot shaft 524b at a third point 526c. In some examples, the hinge 500 can include a fourth link 522d opposite the third link 522c extending from the second central shaft 520b. In some examples, the second central shaft 520b can include a fourth spring 528d opposite the third spring 528c and coupled to the fourth link 522d. In some examples, a distal end of the third link 522d can be configured to rotatably engage an inner portion 530d of the arm frame 502. In some examples, the fourth link 522d can be pivotally coupled to the second pivot shaft 524b at a fourth point 526d.

In some examples, the central shafts 520a-b are offset from the axis of rotation of the hinge. As the hinge 500 rotates, the inner portions 530a-d pull the links 522a-d, causing the links 522a-d to pivot about axes defined by points 526a-d, which changes the lengths the springs 528a-d and creates an unstable configuration shown in FIG. 5B. FIG. 5A shows the central shafts 520a-b, the links 522a-d, the pivot shafts 524a-b, the springs 528a-d and the inner portions 530a-d in the open and the closed positions of the hinge 500, which are stable. In some examples, the springs 528a-d are compressed when the hinge 500 rotates. In other examples, the springs 528a-d are stretched when the hinge 500 rotates. In some examples, the links 522a-d can be secured to the respective inner portions 530a-d. In other examples, the tensile force from the springs 528a-d can keep the links 522a-d in contact with the respective inner portions 530a-d and prevent the hinge 500 from separating. In some examples, the central shafts 520a-b and the pivot shafts 524a-b can be rigid. Rigid central shafts 520a-b and pivot shafts 524a-b can create a thin hinge mechanism with predictable gaps on either side, facilitating bi-stability of the hinge 500 while allowing space in the hinge 500 for electrical connectors or other components.

Any of the features, components, and/or parts, including the arrangements and configurations thereof shown in FIG. 5A-5B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 5A-5B. Another cross-sectional view of a hinge mechanism is described below in reference to FIGS. 6A-6C.

FIGS. 6A-6C show a cross-sectional view of a hinge 600 taken at the plane 211 shown in FIG. 2A. FIGS. 6A-6C show the relative positions of the internal components of the hinge 600 throughout the rotation of the hinge 600. In some examples, the hinge 600 can be substantially similar to the hinge 500 described above in reference to FIGS. 5A-5B. As shown, the hinge 600 includes an arm 606 and a hinge housing 608. The hinge housing 608 can couple the arm 606 to a frame 602. In some examples, the hinge 600 can include a first shaft 620a and a second shaft 620b. In some examples, a first link 622a can extend from the first shaft 622a. The first link can pivotally engage an inner portion 630a. In some examples, a third link 622c can extend from the second shaft 622b and pivotally engage a third inner portion 630c. In some examples, the hinge 600 can also include a second link and a fourth link corresponding the second link 522b and the fourth link 522d shown in FIGS. 5A-5B opposite the first link 622a and the third link 622c. In some examples, the hinge 600 can also include a second inner portion and a fourth inner portion corresponding the second inner portion 530b and the fourth inner portion 530d shown in FIGS. 5A-5B opposite the first inner portion 630a and the third inner portion 630c.

In the first position shown in FIG. 6A, the hinge 600 is closed. The hinge 600 can be a bi-stable hinge, and the position shown in FIG. 6A can be stable. As the hinge rotates to the position shown in FIG. 6B, the first link 622a rotates about the pivotal engagement with the first inner portion 630a and the third link 622c rotates about the pivotal engagement with the third inner portion 630c. As the hinge 600 approaches an approximate intermediate position, shown in FIG. 6B, the first inner portion 630a pulls the first link 622a and the third inner portion 630c pulls the third link 622c, causing at least one spring to change lengths as described above in reference to FIGS. 5A-5B. The change in length of the one or more springs creates instability, biasing the hinge toward an open or a closed position. As the hinge 600 rotates toward a closed position shown in FIG. 6C, the links 622a and 622c rotate about the inner portions 630a and 630c and release the energy from the springs. Here, the pull of the inner portions 630a and 630c on the relative links 622a and 622c is created because the shafts 620a-b are offset from the axis or rotation of the hinge 600.

Any of the features, components, and/or parts, including the arrangements and configurations thereof shown in FIG. 6A-6C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 6A-6C. More examples of hinges and hinge mechanisms are described in detail below.

FIGS. 7A-7B show a cross-sectional view of another example of a hinge 700 taken at the plane 213 shown in FIG. 2A. The hinge shown in FIGS. 7A-7B can be a bi-stable hinge including rotating parts and energy storage parts that interact to create bi-stability in an open and closed position, with an unstable set of middle positions. The hinge 700 can include an arm 706, a frame 702, a first shaft 734a, and a first link 732a extending from the first shaft 734a. In some examples, the arm 706 can also include a first retention member 730a, and the first link 732a can be configured to pivotally engage the retention member 730a. In some examples, the hinge 700 can also include a second link 732b extending from the first shaft 734a and pivotally engaged with a second retention member 732b of the frame 702. In some examples, the hinge 700 can include a second shaft 734b and a third link 732c extending from the second shaft 734b. In some examples, the arm 706 can also include a third retention member 730c, and the third link 732c can be configured to pivotally engage the retention member 730c. In some examples, the hinge 700 can also include a fourth link 732d extending from the second shaft 734b and pivotally engaged with a fourth retention member 732d of the frame 702.

The retention members 730a-d can include separate portions of material secured to the hinge 700, arm 706, and/or frame 702, or features integrally formed with the hinge 700, arm 706, and/or frame 702. The retention members 730a-d can include protruding features shaped to engage or be engaged with the links 732a-d such that the shafts 734a-b and other components maintain position and are assembled during operation of the hinge 700. In the illustrated example of FIGS. 7A and 7B, the retention members 730a-d include protruding shelves or ridges with which respective links 732a-d are hooked, contacting, pressed, or otherwise physically engaged.

In some examples, at least one of the first shaft 734a and the second shaft 734b can be an energy storage member. In some examples, energy storage members can be coupled to the links 732a-d. In some examples, the energy storage member can be metal or plastics. In some examples, the energy storage member can be manufactured from spring steel or shape memory alloys such as nitinol. The energy storage member can be a biasing element. The energy storage member can be a spring, such as a coil spring, leaf spring, or other kind of spring. The energy storage member can be a member configured to store energy, release energy by way of a biasing force, and be reloaded with energy for further use FIG. 7A shows the hinge 700 in a neutral position. FIG. 7A can represent either an open position, or a closed position, both of which are stable. As the hinge 700 rotates, the links 732a-d rotate about the respective retention members 730a-d (as described below in relation to FIGS. 8A-8C), the effective length of the links 732a-d between the retention members 730a-d and the respective shafts 734a-b increases, bending the shafts 734a-b as shown in FIG. 7B. As the shafts 734a-b bend, the energy stored in the shafts 734a-b biases the hinge toward either the open position or the closed position. In some examples, a rotation of the hinge 700 causes the links 732a-d to deform the energy storage member such that the links 734a-d change an energy characteristic of the energy storage member, creating a bi-stable hinge. In some examples, the first shaft 734a can be fixed to the second shaft 734b.

Any of the features, components, and/or parts, including the arrangements and configurations thereof shown in FIG. 7A-7B can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 7A-7B. Another cross-sectional view of a hinge mechanism is described below in reference to FIGS. 8A-8C.

FIGS. 8A-8C show another cross-sectional view of a hinge 800 taken at the plane 211 shown in FIG. 2A. FIGS. 8A-8C show the relative positions of the internal components of the hinge 800 throughout the rotation of the hinge 800. In some examples, the hinge 800 can be substantially similar to the hinge 700 described above in reference to FIGS. 7A-7B. As shown, the hinge 800 includes an arm 806 and a hinge housing 808. The hinge housing 808 can couple the arm 806 to a frame 802. In some examples, the hinge 800 can include a first shaft 834a and a second shaft 834b. In some examples, a first link 832a can extend from the first shaft 834a. The first link 832a can pivotally engage a retention member 830a. In some examples, a third link 832c can extend from the second shaft 834b and pivotally engage a third retention member 830c. In some examples, the hinge 800 can also include a second link and a fourth link corresponding the second link 732b and the fourth link 732d shown in FIGS. 7A-7B opposite the first link 832a and the third link 832c. In some examples, the hinge 800 can also include a second inner portion and a fourth inner portion corresponding the second retention member 730b and the fourth retention member 730d shown in FIGS. 7A-7B opposite the first retention member 830a and the third retention member 830c.

In the first position shown in FIG. 8A, the hinge 800 is closed. The hinge 800 can be a bi-stable hinge, and the position shown in FIG. 8A can be stable. As the hinge rotates to the position shown in FIG. 8B, the first link 832a rotates about the pivotal engagement with the first retention member 830a and the third link 832c rotates about the pivotal engagement with the third retention member 830c. As the hinge 800 approaches an approximate middle position, shown in FIG. 6B, the links 832a and 832c push the first shaft 834a and the second shaft 834b toward one another, bending the shafts 834a, 834c and storing energy. As the hinge 800 closes, as shown in FIG. 8C, the length between the retention members 830a-b and the shafts 834a-b decreases, and the energy storage members of the shafts 834a-b release their energy, creating a stable position again. In some examples, the hinge 800 defines a first, vertical, axis of rotation, and the links 832a, 832c rotate about a second axis of rotation perpendicular to the first axis of rotation. In some examples, the links 832a, 832c are coupled to the shafts 834a-b and rotate about an axis defined by the shafts 834a-b.

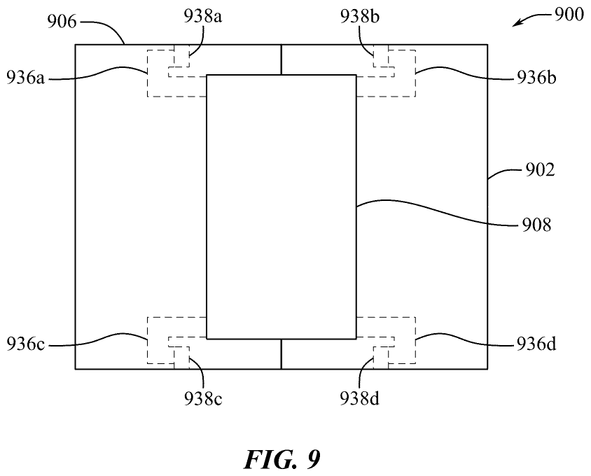

Any of the features, components, and/or parts, including the arrangements and configurations thereof shown in FIG. 8A-8C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 8A-8C. Hinge housings and securements are discussed below in reference to FIG. 9.

The various hinges described herein can includes housing that contain, secure, and/or hide internal hinge components during operation and stowing of the devices described herein. FIG. 9 shows an example of a portion of a device 900, including a frame 902 and a securement arm 906, which can be substantially similar to other frames and securement arms described herein with reference to other figures, and a hinge housing 908. In at least one example, in order to retain the hinge in position between the arm 906 and the frame 902 as shown, in either an open or closed position, the device 900 can include hinge securement features 938a-d. The features 938a-d can include protrusions, ledges, or other physical features extending from inner surfaces of the frame 902 and arm 906.

For example, the first feature 938a can extend from an internal surface of the frame and the second feature 938b can extend from an inner surface of the arm 902, with third and fourth features 938c and 938d extending from opposing inner surfaces of the frame 902 and arm 906, respectively.

In addition, the hinge mechanism can include one or more mating features 936a-d extending from the housing 908 to engage with the securement features 938a-d, respectively, and securing the housing 908 and the hinge mechanism in place. As shown in the illustrated example of FIG. 9, the mating features 936a-d can be hooked or otherwise shaped to mechanically engage with the securement features 938a-d. In other examples, the securement features 938a-d can be hooked, or both the securement features 938a-d and the mating features 936a-d can be hooked or otherwise shaped and positioned to engage with one another in such a way that the housing 908 of the hinge mechanism remains in position for proper functioning and movement of the arm 906 relative to the frame 902.

Any of the features, components, and/or parts, including the arrangements and configurations thereof shown in FIG. 9 can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 9.

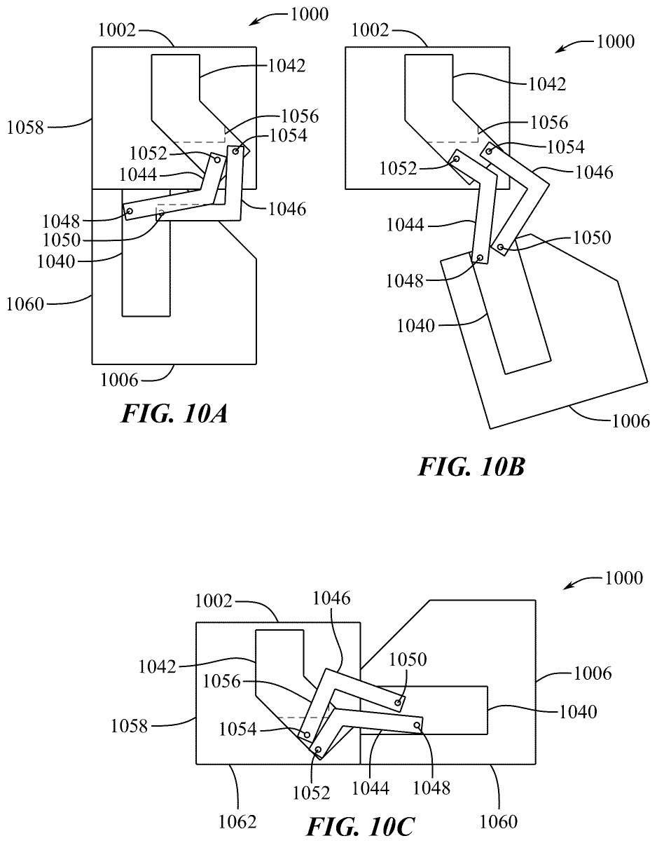

FIGS. 10A-10C illustrate another example of a hinge assembly for enabling pivoting movement between the frame 1002 and securement arm 1006 of a device 1000. The frame 1002 and arm 1006 of the device 1000 shown in FIGS. 10A-10C can be substantially similar to other frames and securement arms shown in other figures and described herein. In the illustrated example of FIG. 10A, the arm 1006 is in an open position relative to the frame 1002, for example when a user is donning the device 1000. FIG. 10C shows the arm 1006 in a closed position relative to the frame 1002, for example when the device 1000 is stowed, and FIG. 10B shows the arm 1006 in an intermediate position between the open position and the closed position.

The hinge mechanism can include a four-bar linkage including a first link 1040, a second link 1042, a third link 1044, and a fourth link 1046. The third link 1044 can be pivotally secured to the second link 1042 at pivot point 1052 and pivotally secured to the first link 1040 at pivot point 1048. The fourth link can be pivotally secured to the second link 1042 at pivot point 1054 and pivotally secured to the first link 1040 at pivot point 1050. The second link 1042 can be fixed in position relative to the frame 1002 such that the frame 1002 itself can be considered to be, or be a part of, the second link 1042, as described herein. Likewise, the first link 1040 can be fixed in position relative to the arm 1006 such that the arm 1006 itself can be considered to be, or be a part of, the first link 1040, as described herein.

In at least one example, the second link 1042 can include a stop 1056 configured to receive or physically interact and contact with at least the fourth link 1046. As shown in the closed position of FIG. 10C, the stop 1056 prevents the fourth link 1046 to continue pivoting and moving past the stop 1056, which in turn prevents the arm 1006 from rotating relative to the frame 1002 beyond the point shown in FIG. 10C. In one example, the stop 1056 can be a separate component coupled to the second link 1042 or the frame 1002. In one example, the stop 1056 can be a physical feature such as a ledge, protrusion, or other feature formed integrally with the second link 1042 or frame 1002 as a part of the shape of the second link 1042 or frame 1002. Also, in at least one example, an electrical connector, such as the electrical connector 112 shown in FIG. 1A, can be included, passed through, or a part of the first link 1040.

The four-bar linkage assembly of the hinge shown in FIGS. 10A-10C can guide a movement of the arm 1006 relative to the frame 1002 when moving from the open position to the stowed position such that when the arm 1006 is in the open position as shown in FIG. 10A, an outer surface 1058 of the frame 1008 seamlessly transitions to an outer surface 1060 of the arm 1006 and when the arm 1006 is in the closed position as shown in FIG. 10C, the outer surface of the arm 1060 is flush or sub-flush with a distal end or surface 1062 of the frame 1002. In this way, in the closed position, the arm 1006 is folded into a volumetric envelope of the frame, as discussed above with reference to other figures, thus reducing the volumetric footprint of the device 1000 in the stowed/closed position and protecting the arm 1006. In the open position, the outer surfaces 1058, 1060 can be flush, near flush, or otherwise arranged to provide a continuous, seamless aesthetic to the user and others when the device 1000 is being used.

Any of the features, components, and/or parts, including the arrangements and configurations thereof shown in FIG. 10A-10C can be included, either alone or in any combination, in any of the other examples of devices, features, components, and parts shown in the other figures described herein. Likewise, any of the features, components, and/or parts, including the arrangements and configurations thereof shown and described with reference to the other figures can be included, either alone or in any combination, in the example of the devices, features, components, and parts shown in FIG. 10A-10C.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

1. A wearable electronic display device, comprising:
a display window;
a frame coupled to the display window;
an arm extending from the frame;
an electrical connector electrically coupling the arm to the frame; and
a hinge coupling the arm to the frame, the hinge comprising:
a housing;
a central shaft disposed within the housing; and
a link extending from the shaft, a distal end of the link configured to rotatably engage an inner portion of the arm.

2. The wearable electronic display device of claim 1, further comprising a pivot shaft fixed to the central shaft and rotatably coupled to the link.

3. The wearable electronic display device of claim 2, further comprising a spring coupled to the central shaft and the link.

4. The wearable electronic display device of claim 3, wherein a rotation of the hinge causes the link to:
rotate about a first axis defined by the inner portion of the arm;
rotate about a second axis defined by the pivot shaft; and
change a length of the spring.

5. The wearable electronic display device of claim 1, wherein the central shaft comprises an energy storage member.

6. The wearable electronic display device of claim 5, wherein the link deforms the energy storage member in response to a rotation of the hinge.

7. The wearable electronic display device of claim 1, wherein the electrical connector passes through the hinge.

8. The wearable electronic display device of claim 1, wherein the hinge comprises a bi-stable hinge.

9. A hinge for a wearable electronic display device, comprising:
a housing;
a shaft disposed within the housing and comprising an energy storage member;
a link extending from the shaft; and
a retention member;
wherein:
the energy storage member is coupled to the link;
the link rotatably engages the retention member; and
a rotation of the hinge causes the link to deform the energy storage member such that the link changes an energy characteristic of the energy storage member.

10. The hinge of claim 9, wherein the hinge comprises a bi-stable hinge.

11. The hinge of claim 9, wherein the energy storage member comprises a spring.

12. The hinge of claim 9, wherein:
the hinge defines an axis of rotation;
the hinge further comprises an electrical connector; and
the shaft is disposed between the electrical connector and the axis of rotation.

13. The hinge of claim 9, wherein:
the hinge defines a first axis of rotation; and
the link is configured to rotate about a second axis of rotation perpendicular to the first axis of rotation.

14. The hinge of claim 9, wherein:
the shaft is a first shaft; and
the hinge further comprises a second shaft fixed to the first shaft and rotatably coupled to the link.

15. The hinge of claim 9, wherein:
the shaft is fixed to the housing; and
the link rotates about an axis defined by the shaft.

16. A wearable electronic display device, comprising:
a frame coupled to a display and defining a volumetric envelope;
an arm extending from the frame; and
a hinge coupling the arm to the frame, the hinge comprising a four-bar linkage;
wherein:
the hinge defines a first position of the arm relative to the frame and a second position of the arm relative to the display;
the four-bar linkage guides the arm between the first position and the second position;
the arm is disposed outside the volumetric envelope in the first position; and
the arm is disposed within the volumetric envelope in the second position.

17. The wearable electronic display device of claim 16, wherein:
the four-bar linkage comprises a first link, a second link, a third link, and a fourth link;
the wearable electronic device further comprises an electrical connector; and
the electrical connector is disposed within the first link.

18. The wearable electronic display device of claim 17, wherein the second link defines a stop feature configured to receive the first link.

19. The wearable electronic display device of claim 16, wherein:
the arm is a first arm;
the wearable electronic device comprises a second arm;
the second arm is disposed outside the volumetric envelope in the first position; and
the second arm is disposed within the volumetric envelope in the second position.

20. The wearable electronic display device of claim 16, wherein the hinge comprises a bi-stable hinge.
